(19) United States
(12) Patent Application Publication
(10) Pub. No.: US 2016/0335372 A1
(43) Pub. Date: Nov. 17, 2016

(54) SYSTEMS AND METHODS FOR SEARCH WITH PRIORITIES BY ASSIGNING WEIGHTS TO QUERY TERMS

(71) Applicant: SAP SE, Walldorf (DE)

(72) Inventor: Markus Latzina, Wiesenbach (DE)

(21) Appl. No.: 14/713,750

(22) Filed: May 15, 2015

(51) Int. Cl. G06F 17/30

(52) U.S. Cl. CPC G06F 17/30979; G06F 17/30663

(57) ABSTRACT

The present invention generally relates to the search of enterprise systems, and more particularly, to the use of one or more weighting factor(s) to identify the relevance of individual search terms of a search query. The systems and methods receive a user query from a remote device, the user query containing one or more search terms, assign a first set of weights to each search term contained in the user query, upon receiving search results corresponding to the user query from a backend server, transmit the search results to the remote device, receive a user selected object, the user selected object being chosen from among the search results, and assign a second set of weights to each search term of the user query based upon the selected object.

### FIELD OF INVENTION

The present invention generally relates to the search of enterprise systems, and more particularly, to the use of one or more weighting factor(s) to identify the relevance of individual search terms of a search query statement.

### BACKGROUND

In today's hyper information age, it is not uncommon for individuals to continually manage large amounts of information. Many existing applications have been developed to manage a single type of information object. For example, some applications have been developed to manage e-mail messages, calendar entries, tasks, notes, etc. Similarly, some applications have been developed to manage business objects such as purchase orders, sales orders, contracts, service orders, etc. However, existing applications have limited capability to search for particular pieces of information, such as business objects and/or associated objects.

Although many existing applications have search functionalities, their capabilities are limited and may not accurately reflect the intent of the user. For example, in some search tools, a user may select from keywords in order to construct a query statement. In such systems, the resulting search query may be limited to particular keyword(s). Here, the set of keywords may be limited to those proposed by the search tool on the basis of the initial query statement and/or the initial search results. In addition, query terms can be combined only with logical expressions, such as ‘AND’, ‘OR’, and the like. Unfortunately, such logical expressions cannot indicate the relevance of each individual query term to the user.

In light of the drawbacks of existing search tools, the inventor has provided systems and methods for searching business objects. The example systems and methods described herein may assign weights to each of the search terms of a query statement.

### SUMMARY OF THE INVENTION

Accordingly, embodiments of the present invention are generally directed to systems and methods for search with priorities by assigning weights to query terms that substantially obviate one or more problems due to limitations and disadvantages of the related art, as described above.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with a purpose of the present invention, as embodied and broadly described, the systems and methods for search with priorities by assigning weights to query terms receive a user query from a remote device, the user query containing one or more search terms, assign a first set of weights to each search term contained in the user query, upon receiving search results corresponding to the user query from a backend server, transmit the search results to the remote device, receive a user selected object, the user selected object being chosen from among the search results, and assign a second set of weights to each search term of the user query based upon the selected object.

In some embodiments, the values of the first and/or second sets of weights may be user-defined, calculated according to a mathematical function or algorithm, or be determined based upon a user profile.

In some embodiments, terms associated with the user selected object may supplement or replace the search terms of the user query during a subsequent query of the backend server.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure.

FIG. 1 is a system diagram depicting an architectural overview of a networked system for generating dynamic search results according to an example embodiment.

FIG. 2 illustrates a representative view of an example search application display according to an example embodiment.

FIG. 3 illustrates a method for generating dynamic search results according to an example embodiment.

FIG. 4 illustrates a representative view of an example search application display according to another example embodiment.

FIG. 5 illustrates a representative architecture of an electronic device according to an example embodiment.

### DETAILED DESCRIPTION

Reference will now be made in detail to the embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

Embodiments of user interfaces and associated methods for using an electronic device are described. In some embodiments, the electronic device is a portable communication device (e.g., a mobile phone or tablet). The user interface may include a touchscreen and/or other input/output devices. In the discussion that follows, a portable communications device may be used as an example embodiment. It should be understood, however, that the user interfaces and associated methods may be applied to other devices, such as personal computers and laptops, which may include one or more other physical user interface devices, such as a keyboard and or mouse.

The electronic device may support a variety of applications, such as telephone, text messenger, and search applications. The various applications that may be executed on the device may use at least one common physical user-interface device, such as a touchscreen. One or more functions of the touchscreen as well as corresponding information displayed on the device may be adjusted and/or varied from one application to another and/or within a respective application. In this way, a common physical architecture of the device may support a variety of applications with user interfaces that are intuitive and transparent. In the discussion that follows, a search application is used as an example embodiment, but it should be understood that the user interfaces and associated methods may be applied to other applications.

By applying a search application according to embodiments of the present disclosure, users will be better equipped to analyze vast amounts of data, and make more informed decision in real-time. The search application of the present disclosure avoids data privacy problems by relying on information already available to user. In addition, the algorithms used to derive business object and other search results may be executed locally on user's electronic device or on a remote search server. In either case, relationships between users and business objects are less computationally intensive and may be determined more quickly.

The described systems and methods identify business objects and other search results based upon the relevance of query search terms. For example, the various embodiments may select and/or deselect search terms from terms of a user-entered search query. In another example, search terms may be assigned relative weights as indications of their respective relevance. Such weights may be user-defined or calculated by the search application. In addition, search results may be displayed in an order based upon their calculated relevance.

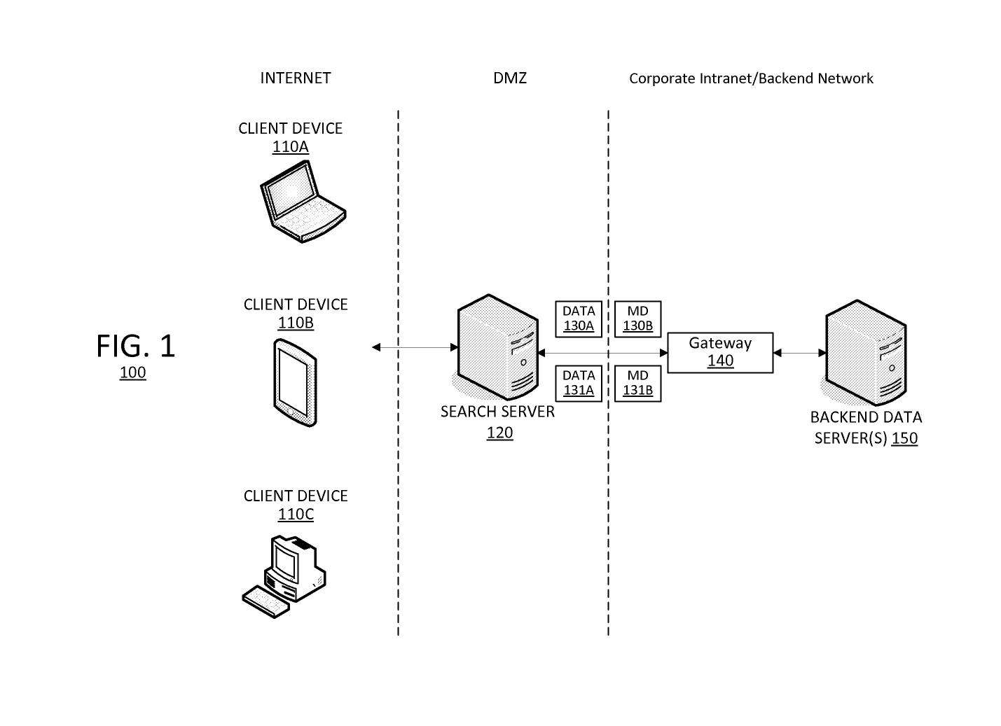

FIG. 1 is a system diagram depicting an architectural overview of a networked system 100 for generating dynamic search results according to an example embodiment. The system 100 includes client devices 110A, 110B, and 110C (collectively, 110), search server 120, gateway 140, and backend data server(s) 150. Communications between components of the system 100 may utilize a variety of data transfer protocols, such as HTTP methods (e.g., get, post, put, and delete) or web socket, to query, interact, and manipulate data. In addition, the components of system 100 may be implemented using conventional and/or cloud networks.

As illustrated, the networked system 100 includes one or more client devices 110, being network accessible via an Internet connection, and connected to a search server 120 in a network demilitarized zone (DMZ). Collectively, devices such as client devices 110 and search server 120 may be referred to as a dynamic frontend system. Client devices 110 may include a variety of devices which may include, for example, a mobile device (e.g., mobile phone or smartphone), a personal computer, a laptop, a tablet, and the like. Each of the client devices 110 is configured to transmit and receive data and metadata communications with the search server 120. The data communications (e.g., 130 and 131) may be exchanged with backend data server(s) 150 via optional gateway 140.

The search server 120 may be configured to transmit data 130A, such as a search request, to an enterprise data system such as a backend server 150 in a corporate intranet/backend network. The optional gateway 140 may translate requests, such as search requests included in data 130A, to other proprietary protocols, such as remote function call (RFC). Alternatively, the functions of gateway 140 may be implemented at backend server(s) 150 such that it may directly receive requests. The backend server(s) 150 may be configured to process the request(s), retrieve data and/or perform data operations as an appropriate response to a request, and return a response for transmission back to the gateway 140. Again, the gateway 140 may be used to translate a proprietary protocol. The data response 131, including search results, may be transmitted from gateway 140 (which is located in the backend network) to the appropriate client device 110 through search server 120.

Search server 120 may assign weight values to one or more terms contained within the query statement. Additionally, the search server 120 may receive a user-selected object from among the search results. Here, during a second or subsequent stage of a search, the user may have selected an object from the prior search results. Terms associated with the selected search result may be used to replace or supplement the initial query statement. Both the initial query search terms and/or the subsequent search terms may be assigned weights.

To handle search requests, search server 120 may include a data handler adapted to retrieve data and/or metadata from the gateway 140 and/or backend server(s) 150. The metadata may include information about the type of the data (e.g., date, type of input field, read-only/editable, function, etc.) as well as information about the relevance of the data. Using the information gathered from backend server(s) 150, the search server 120 may aggregate data from data server(s) 150. In addition, the search server 120 may instruct a client device 110 to generate and render user interfaces in a dynamic manner.

One or more backend server(s) 150 may store a variety of data and business objects. Example business objects may include transactional information, quotations, purchase orders, sales orders, contracts, service orders, etc. In addition, business objects may be stored within standalone server(s) or may be integrated with customer relationship management (CRM) and/or enterprise resource planning (ERP) systems. Additionally, the backend server(s) may be implemented as an in-memory database, such as SAP® HANA, and/or other relational databases. Multiple search technologies may be used to query backend server(s) 150, such as enterprise, HANA, C'est Bon, structured query language (SQL), and other search types.

Client device 110 and/or search server 120 may maintain a user profile for each system user. For example, a user profile may track information which may be derived directly from business suite components like objects the corresponding user owns or groups he/she is allocated to. In addition, the user profile may store data on business objects the user recently accessed. In other words, if a user created, deleted, modified, or even viewed a business object, the user's behavior may be stored within the profile. Using the user profile, search server 120 may weight search terms and/or rank the search results. In some instances, user profiles may be based on data relating to a group of users, such as peer groups. In addition, user profiles may relate to interactions with a single or multiple backend server(s) 150. Example groups may designate similarly situated users, such as employees of particular business units, managers, occasional consumers, business customers, etc. In another example, groups may be based upon the role of the user (e.g., sales rep, payroll admin, etc.).

Gateway 140 may be located between the search server 120 and the backend server(s) 150 to intercept data communications, such as data 130, 131. The gateway 140 acts as a middle party with both client and server functionality to handle communications in both directions. The gateway 140 may perform server functions, such as responding to data requests from client devices 110. Data responses may be included in data 131A. The gateway 140 also performs client functions, such as forwarding incoming data requests from the client device 110 to the backend server(s) 150. The gateway 140 may forward a data request 120 to the backend server(s) 150, and receive a corresponding data response 131. The data response 131 may be relayed to the search server 120 as data 131A and metadata 131B.

After receiving the data response 131 from the gateway 140 (and correspondingly, from the backend server(s) 150), the gateway 140 can append metadata 131B to received data 131. Once the data response 131A, 131B is generated by gateway 140, the data response 131A, 131B may be returned to the client device 110 by search server 120. As shown, response data 131A and response metadata 131B may be communicated from the gateway 140 to the search server 120, for communication to the appropriate client device 110.

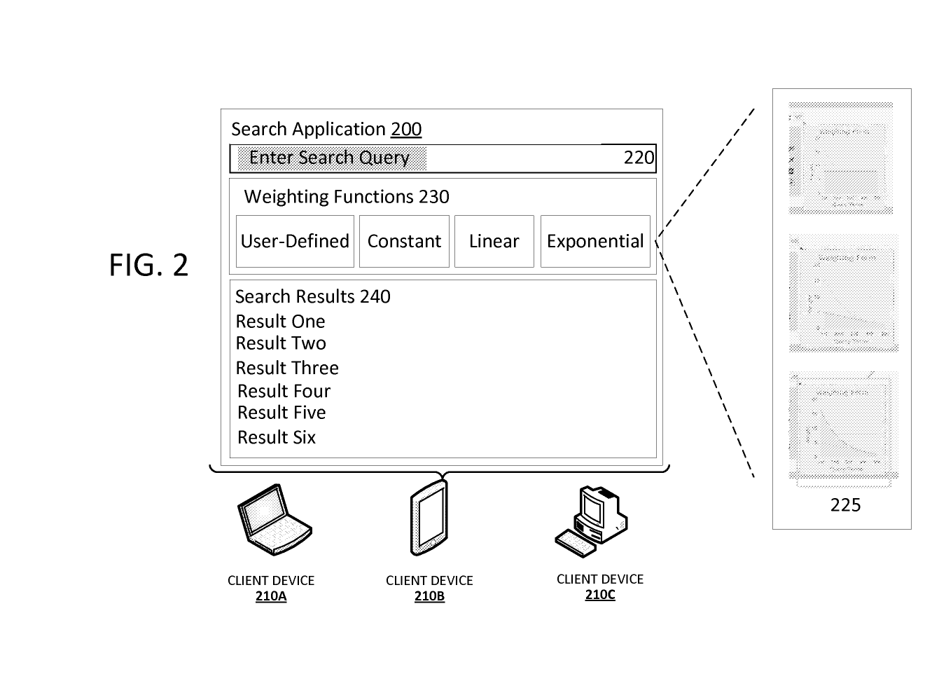

FIG. 2 illustrates a representative view of an example search application display 200 according to an example embodiment. The search application 200 may be displayed on a variety of client devices 210A, 210B, 210C (collectively, 210) which may include, for example, a mobile device (e.g., mobile phone or a smartphone), a personal computer, a laptop, a tablet, and the like. As shown in FIG. 2, the search application 200 includes multiple component sections, such as search query section 220, weighting functions section 230, and search results section 240. Sections 220-240 generally incorporate and/or implement features of the search application, however, the search application and display may further introduce additional modules and/or components.

Within search query section 220, a user may input one or more search terms to form a search query statement. Using the weighting functions section 230, the search application may determine the relative weights of each search term. For example, the relative weights may be user-defined, calculated according to a mathematical function (e.g., constant, linear, division of percentages totaling 100%, logarithmic, exponential, and the like) or algorithm, or be determined based upon a user profile. In some instances, the mathematical function applied to the search term may be graphically displayed, as shown in section 225. Search results generated based upon the desired weighting scheme may be displayed within search results section 240.

In some instances, if the assignment of weights to individual search terms is user-defined, the user may rank each of the individual search terms. Here, the user may designate particular weight values to each search term and/or allow the search application to determine the weight values according to a weighting algorithm. If a user-profile is being used, the search application may calculate weight values based upon the actual usage history of the user, regarding some search terms as more relevant or preferred than others, resulting from usage behavior. In addition, a user may optionally designate whether the order of search terms indicates a relative weight of the search terms.

Assigning of weights to query search terms may be used to trigger the retrieval of different sets of results within search results section 240. In addition, weight values also may be used to indicate the viewing preference of the search results.

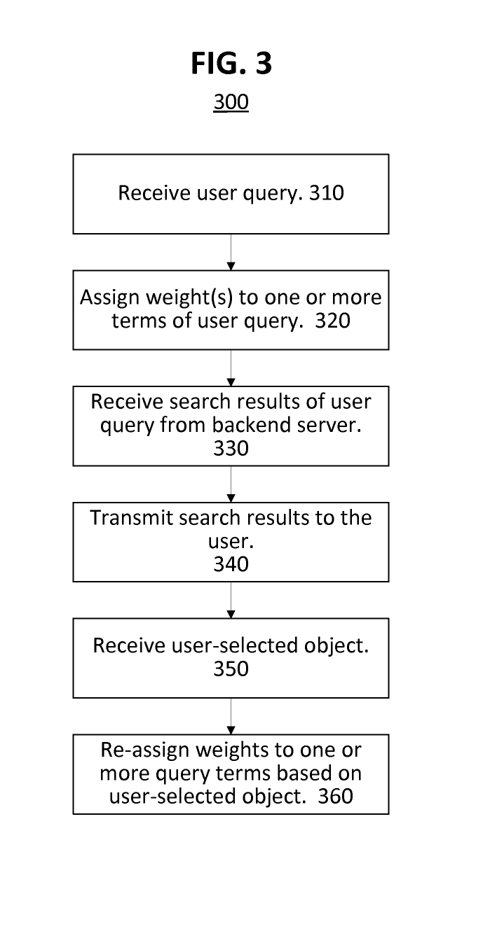

FIG. 3 illustrates a method for generating dynamic search results according to an example embodiment. As will be understood, the example embodiment may differentiate between an initial and a subsequent search stage of a user.

At the outset, the search server may receive a query statement entered by a user of a client device, at 310. For example, a user may input one or more search terms into an input field. In another example, a more complex search interface may contain multiple input fields and logical operators for combining query terms.

At 320, the search server may assign weight values to one or more terms contained within the query statement. After querying the backend server(s), the search server may receive the search results from the backend server, at 330. Subsequently, at 340, the search server may transmit the search results to the client device of the user.

Search results may be provided in a variety of formats. For example, one set of results may contain data abstractions from the search results which in some form or the other match the user's initial query statement. In this type of search result format, search results may be provided as category items. In a particular example, when a user enters the query statement ‘Automobile’ the resulting category terms may be vehicles, vans, trucks, sport utility vehicles, and the like. Alternatively, another set of results may contain individual items on an instance level (e.g., individual database records or web pages which match a user's initial query statement). For example, such search results may correspond to a search of ‘2015 sport utility vehicles.’

Next, at 350, the search server receives a user-selected object from among the search results. Here, during a second or subsequent stage of a search, the user may select an item from the prior results (e.g., category item or instance item) as a search refining item to supplement the initial query statement. A search refining item may supplement or replace the initial query statement in order to retrieve another set of search results which the user deems to be more suitable in relation to their actual search intent.

Lastly, at 360, the initial query terms (if not discarded) and/or the search refining item (from previously retrieved results) may be assigned weights. Such weights may be user-defined or calculated by the search server. For example, within a search application of a user's client device, a dedicated menu may enable the user to assign a weight to each search term or search refining item. In another example, the relative importance of a particular term may be calculated based upon the visual ordering of search terms or search refining items by a user. Here, in a left-to-right reading culture, an item displayed toward the leftward direction may be assigned a higher priority than am item in the rightward direction.

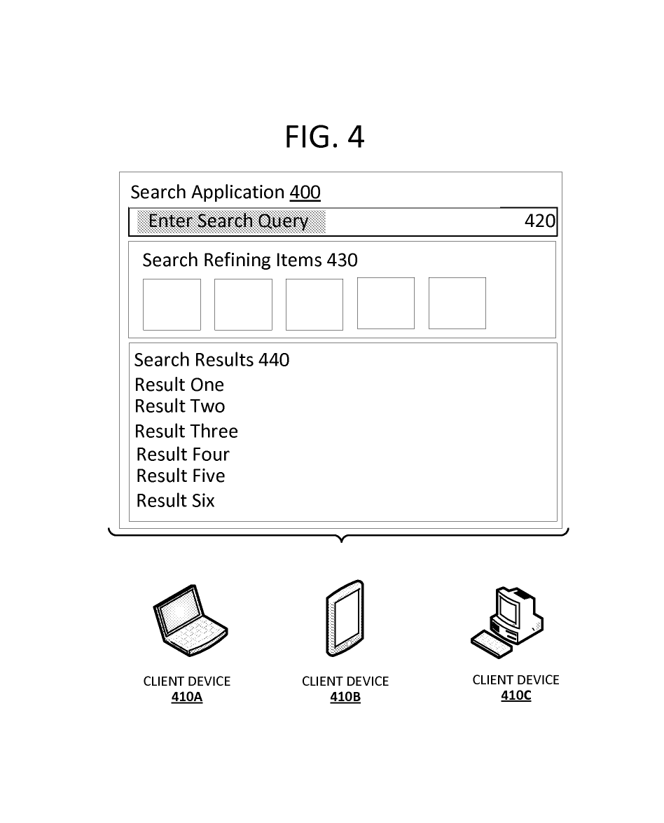

FIG. 4 illustrates a representative view of another example search application display 400 according to an example embodiment. The search application 400 may be displayed on a variety of client devices 410A, 410B, 410C (collectively, 410) which may include, for example, a mobile device (e.g., mobile phone or a smartphone), a personal computer, a laptop, a tablet, and the like. As shown in FIG. 4, the search application 400 includes multiple component sections, such as search query section 420, search refining section 430, and search results section 440. Sections 420-440 generally incorporate and/or implement features of the search application, however, the search application and display may further introduce additional modules and/or components.

Within search query section 420, a user may input one or more search terms to form a search query statement. Alternatively, the user may select one or more of the search refining items 430 to generate a search query statement. The initial and subsequent search queries trigger the retrieval of search result items from one or more backend servers that may be displayed within section 440. Here, the search server receives the query statement and retrieves search results on the basis of establishing matches with respect to the query statement. At the client device 410, a presentation engine displays the search results to the user within search application 400.

Among the search results displayed in section 440, the user may select one or more of the search results to supplement a subsequent search. The various search results may be selected or deselected as search refining items 430, as desired by the user. A subsequent search may be based upon one or more search refining items 430, or a combination of one or more search refining items 420 and the initial search query statement. In addition, one or more weights may be assigned to each search term or refining item during an initial or subsequent search, as described above.

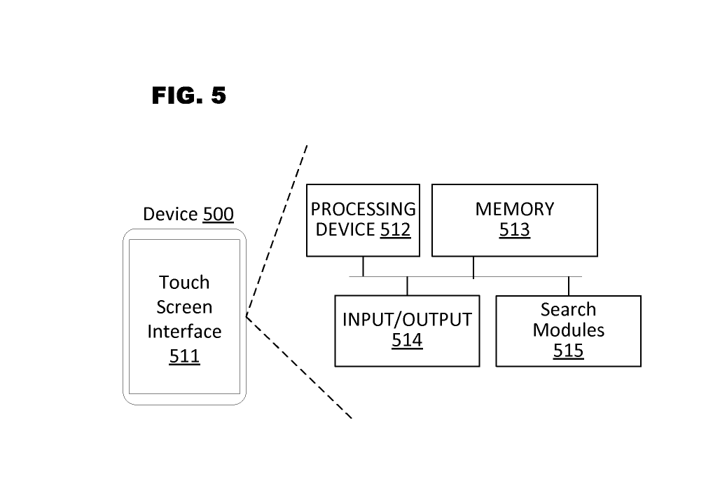

FIG. 5 illustrates a representative architecture of an electronic device according to an example embodiment.

An electronic device 500 may include a touchscreen interface 511, processing device 512, memory 513, and input/output module 514. The touch screen interface 511 may include a display, which may be a touchscreen, capable of displaying data to a user of the electronic device 500. Electronic device 500 may also include search modules 515 that generally implement the functionality of the search application. The components and functions of the search modules 515 are explained in detail with reference to FIGS. 1, 2, 3, and 4.

Although not shown, the touchscreen may include a sensor that may be a capacitive touch detection sensor, configured to detect and track movement on the surface and/or in the vicinity of the display. The sensor may be coupled to a signal processing circuit that is configured to identify, locate, and/or track object movement based on the data obtained from sensor. The input/output module 514 manages the functionality of touch screen interfaced 511. For example, input/output module 514 may include functionality for identifying a component section within the search application. An alternate component section may be selected by touching the alternate component section.

Memory 513 may include a computer readable medium storing application modules, which may include instructions associated with applications and modules of the electronic device 500.

The electronic device 500 may contain a processing device 512, memory 513, and a communications device (not shown), all of which may be interconnected via a system bus. In various embodiments, the device 500 may have an architecture with modular hardware and/or software systems that include additional and/or different systems communicating through one or more networks via one or more communications devices.

Communications devices may enable connectivity between the processing devices 512 in the device 500 and other systems by encoding data to be sent from the processing device 512 to another system over a network and decoding data received from another system over the network for the processing device 512.

In an embodiment, memory 513 may contain different components for retrieving, presenting, changing, and saving data and may include computer readable media. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system. Memory 513 may be capable of storing user inputs and preferences as well as customized displays and templates. In some instances, a cache in memory 513 may store calculated changes to the profit per square foot based on modifications to product displays.

Processing device 512 may perform computation and control functions of a system and comprises a suitable central processing unit (CPU). Processing device 512 may include a single integrated circuit, such as a micro processing device, or may include any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the disclosure to the precise forms disclosed. For example, although the processing device 512 is shown as separate from the modules 514 and 515 and the touchscreen interface 511, in some instances the processing device 512 and the touchscreen interface 511 and/or one or more of the modules 514 and 515 may be functionally integrated to perform their respective functions.

It will be apparent to those skilled in the art that various modifications and variations can be made in the systems and methods for search with priorities by assigning weights to query terms of the present disclosure without departing from the spirit or scope of the disclosure. Thus, it is intended that the present disclosure cover the modifications and variations of this disclosure provided they come within the scope of the appended claims and their equivalents.

What is claimed is:

1. A method comprising:
receiving a user query from a remote device, the user query containing one or more search terms;
assigning a first set of weights to each search term contained in the user query;
upon receiving search results corresponding to the user query from a backend server, transmitting the search results to the remote device;
receiving a user selected object, the user selected object being chosen from among the search results; and
assigning a second set of weights to each search term of the user query based upon the selected object.

2. The method of claim 1, wherein the values of the first and second sets of weights are user-defined.

3. The method of claim 1, wherein the values of the first or second sets of weights are calculated according to one of a linear, logarithmic, and exponential function.

4. The method of claim 1, wherein the values of the first or second sets of weights are calculated according to a user profile.

5. The method of claim 1, wherein the terms associated with the user selected object supplement the search terms of the user query during a subsequent query of the backend server.

6. The method of claim 1, wherein the terms associated with the user selected object replace the search terms of the user query during a subsequent query of the backend server.

7. The method of claim 1, wherein the terms associated with a plurality of user selected objects replace or supplement the search terms of the user query during a subsequent query of the backend server.

8. A non-transitory computer readable storage medium storing one or more programs configured to be executed by a processor, the one or more programs comprising instructions for:
receiving a user query from a remote device, the user query containing one or more search terms;
assigning a first set of weights to each search term contained in the user query;
upon receiving search results corresponding to the user query from a backend server, transmitting the search results to the remote device;
receiving a user selected object, the user selected object being chosen from among the search results; and
assigning a second set of weights to each search term of the user query based upon the selected object.

9. The computer readable storage medium of claim 8, wherein the values of the first and second sets of weights are user-defined.

10. The computer readable storage medium of claim 8, wherein the values of the first or second sets of weights are calculated according to one of a linear, logarithmic, and exponential function.

11. The computer readable storage medium of claim 8, wherein the values of the first or second sets of weights are calculated according to a user profile.

12. The computer readable storage medium of claim 8, wherein the terms associated with the user selected object supplement the search terms of the user query during a subsequent query of the backend server.

13. The computer readable storage medium of claim 8, wherein the terms associated with the user selected object replace the search terms of the user query during a subsequent query of the backend server.

14. The computer readable storage medium of claim 8, wherein the terms associated with a plurality of user selected objects replace or supplement the search terms of the user query during a subsequent query of the backend server.

15. An electronic device comprising:
one or more processors; and
memory storing one or more programs for execution by the one or more processors, the one or more programs including instructions for:
receiving a user query from a remote device, the user query containing one or more search terms;
assigning a first set of weights to each search term contained in the user query;
upon receiving search results corresponding to the user query from a backend server, transmitting the search results to the remote device;
receiving a user selected object, the user selected object being chosen from among the search results; and
assigning a second set of weights to each term of the user query based upon the selected object.

16. The electronic device according to claim 15, wherein the values of the first and second sets of weights are user-defined.

17. The electronic device according to claim 15, wherein the values of the first or second sets of weights are calculated according to one of a linear, logarithmic, and exponential function.

18. The electronic device according to claim 15, wherein the values of the first or second sets of weights are calculated according to a user profile.

19. The electronic device according to claim 15, wherein the terms associated with the user selected object supplement the search terms of the user query during a subsequent query of the backend server.

20. The electronic device according to claim 15, wherein the terms associated with the user selected object replace the search terms of the user query during a subsequent query of the backend server.

21. The electronic device according to claim 15, wherein the terms associated with a plurality of user selected objects replace or supplement the search terms of the user query during a subsequent query of the backend server.
